(19) United States
(12) Patent Application Publication
(10) Pub. No.: US 2010/0250523 A1
(43) Pub. Date: Sep. 30, 2010

(54) SYSTEM AND METHOD FOR LEARNING A RANKING MODEL THAT OPTIMIZES A RANKING EVALUATION METRIC FOR RANKING SEARCH RESULTS OF A SEARCH QUERY

(75) Inventors: Rong Jin, Okemos, MI (US); Jianchang Mao, San Jose, CA (US); Hamed Valizadegan, East Lansing, MI (US); Ruofei Zhang, San Jose, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/415,939

(22) Filed: Mar. 31, 2009

(51) Int. Cl. G06F 17/30; G06F 15/18

(52) U.S. Cl. 707/723; 706/12; 707/E17.014; 707/E17.017

(57) ABSTRACT

An improved system and method for learning a ranking model that optimizes a ranking evaluation metric for ranking search results of a search query is provided. An optimized nDCG ranking model that optimizes an approximation of an average nDCG ranking evaluation metric may be generated from training data through an iterative boosting method for learning to more accurately rank a list of search results for a query. A combination of weak ranking classifiers may be iteratively learned that optimize an approximation of an average nDCG ranking evaluation metric for the training data by training a weak ranking classifier at each iteration for each document in the training data with a computed weight and assigned class label, and then updating the optimized nDCG ranking model by adding the weak ranking classifier with a combination weight to the optimized nDCG ranking model.

### FIELD OF THE INVENTION

The invention relates generally to computer systems, and more particularly to an improved system and method for learning a ranking model that optimizes a ranking evaluation metric for ranking search results of a search query.

### BACKGROUND OF THE INVENTION

Learning to rank is a relatively new field and has attracted the focus of many machine learning researchers in the last decade because of its growing application in the areas like information retrieval (IR) and recommender systems. Leaning to rank has developed its own evaluation measures such as Normalized Discounted Cumulative Gain (nDCG) and Mean Average Precision (MAP). In the simplest form, known as the point-wise approaches, ranking can be treated as a classification or regression problem by learning the numeric rank value of objects as an absolute quantity. See, for example, Li, P., Burges, C., and Wu, Q., Mcrank: Learning to Rank Using Multiple Classification and Gradient Boosting, In J. Platt, D. Koller, Y. Singer and S. Roweis (Eds.), Nips 2007, pp. 897-904, Cambridge, Mass., MIT Press, 2008; and Nallapati, R., Discriminative Models for Information Retrieval, SIGIR 2004, pp. 64-71, New York, N.Y., ACM, 2004. This group of algorithms assumes that the relevance is absolute and query independent. The second group of algorithms, known as the pair-wise approaches, considers the pair of objects as independent variables and learns a classification or regression model to correctly order the training pairs. See for example, Herbrich, R., Graepel, T., and Obermayer, K., Support Vector Learning for Ordinal Regression, ICANN 1999, pp. 97-102, 1999; Freund, Y., Iyer, R., Schapire, R. E., and Singer, Y., An Efficient Boosting Algorithm for Combining Preferences, J. Mach. Learn. Res., 4, 933-969, 2003; Burges, C., Shaked, T., Renshaw, E., Lazier, A., Deeds, M., Hamilton, N., and Hullender, G., Learning to Rank Using Gradient Descent, ICML 2005, pp. 89-96, New York, N.Y., ACM 2005; Cao, Y., Xu, J., Liu, T.-Y., Li, H., Huang, Y., and Hon, H.-W., Adapting Ranking SVM to Document Retrieval, SIGIR 2006, pp. 186-193, New York, N.Y., ACM, 2006; Tsai, M., yan Liu, T., Qin, T., hsi Chen, H., and ying Ma, W., Frank: A Ranking Method With Fidelity Loss, SIGIR, 2007; and Jin, R., Valizadegan, H., and Li, H., Ranking Refinement and Its Application to Information Retrieval, WWW 2008, pp. 397-406, New York, N.Y., ACM, 2008. The main problem with these approaches is that their loss functions are related to individual documents while most evaluation metrics of information retrieval measure the ranking quality for individual queries, not documents.

This mismatch has motivated additional algorithms known as list-wise approaches for information ranking. The list-wise approaches treat each ranking list of documents for a query as a training instance. See for example, Qin, T., Yan Liu, T., Feng Tsai, M., dong Zhang, X., and Li, H., Learning to Search Web Pages With Query-level Loss Functions, Technical Report, 2006; Burges, C. J. C., Ragno, R., and Le, Q. V., Learning to Rank with Non-smooth Cost Functions, NIPS 2006, pp. 193-200, MIT Press, 2006; Cao, Z., and Yan Liu, T., Learning to Rank: From Pair-wise Approach to List-wise Approach, ICML 2007, pp. 129-136, 2007; Yue, Y., Finley, T., Radlinski, F., and Joachims, T., A Support Vector Method for Optimizing Average Precision, SIGIR 2007, pp. 271-278, New York, N.Y., ACM, 2007; Xia, F., Liu, T.-Y., Wang, J., Zhang, W., and Li, H., List-wise Approach to Learning to Rank: Theory and Algorithm, ICML 2008, pp. 1192-1199, New York, N.Y., ACM, 2008; Taylor, M., Guiver, J., Robertson, S., and Minka, T., Softrank: Optimizing Non-smooth Rank Metrics, WSDM 2008, pp. 77-86, New York, N.Y., ACM, 2008. Unlike the point-wise or pair-wise approaches, the list-wise approaches aim to optimize the evaluation metrics such as NDCG and MAP. The main difficulty in optimizing these evaluation metrics is that both NDCG and MAP are dependent on the rank position of objects induced by the ranking function, not the numerical values output by the ranking function. In the past studies, this problem was addressed either by the convex surrogate of the IR metrics or by heuristic optimization methods such as the genetic algorithm.

The list-wise approaches can be classified into two categories. The first group of approaches directly optimizes the IR evaluation metrics. Most IR evaluation metrics depend on the sorted order of objects, and are non-convex in the target ranking function. To avoid the computational difficulty, these approaches either approximate the metrics with some convex functions or deploy ad-hoc methods such as the genetic algorithm described in Yeh, J.-Y., Lin, Y.-Y., Ke, H.-R., and Yang, W.-P., Learning to Rank for Information Retrieval Using Genetic Programming, LR4IR 2007, New York, N.Y., ACM, 2007 for non-convex optimization. Burges et al., 2006, present a list-wise approach named LamdaRank. It addresses the difficulty in optimizing IR metrics by defining a virtual gradient on each object after the sorting. While Burges et al., 2006, provided a simple test to determine if there exists an implicit cost function for the virtual gradient, the theoretical justification for the relation between the implicit cost function and the IR evaluation metric is incomplete. AdaRank introduced in Xu, J., and Li, H., Adarank: A Boosting Algorithm for Information Retrieval, SIGIR 2007, pp. 391-398, New York, N.Y., ACM, 2007, deploys heuristics to embed the IR evaluation metrics in computing the weights of examples for implementation of weak rankers. One major problem with AdaRank is that its convergence is conditional and not guaranteed. SVM-MAP described in Yue et al., 2007, relaxes the MAP metric by incorporating this measure into the constraints of SVM. However, SVM-MAP is only designed for optimizing MAP. Moreover, it only considers the binary relevancy and cannot be applied to the data sets that have with more than two levels of relevance judgments.

The second group of list-wise algorithms defines a list-wise loss function as an indirect way to optimize the IR evaluation metrics. RankCosine introduced in Qin et al., 2006, uses cosine similarity between the ranking list and the ground truth as a query level loss function. List-Net presented in Cao and yan Liu, 2007, adopts the KL divergence for loss function by defining a probabilistic distribution in the space of permutation for learning to rank. ListMLE described in Xia et al., 2008, employs the likelihood loss as the surrogate for the IR evaluation metrics. The main problem with this group of approaches is that the connection between the list-wise loss function and the targeted IR evaluation metric is unclear, and therefore optimizing the list-wise loss function may not necessarily result in the optimization of the IR metrics.

What is needed is a system and method that may directly optimize evaluation measures for learning to rank such as nDCG and MAP for more accurately ranking a list of documents for a query. Such a system and method should be capable of efficient implementation, guarantee the convergence of optimization of the evaluation metric, and have a solid theoretical foundation for the relationship between the evaluation metric and any approximation of the evaluation metric that may be optimized.

### SUMMARY OF THE INVENTION

Briefly, the present invention may provide a system and method for learning a ranking model that optimizes a ranking evaluation metric for ranking search results of a search query. In various embodiments, an optimized nDCG ranking model generator that optimizes an nDCG ranking evaluation metric may be operably coupled to a server and to a computer-readable storage that stores training data that includes sets of a training query and a ranked list of documents which each have a relevance score. The optimized nDCG ranking model generator may construct from the training data and store in the computer-readable storage an optimized nDCG ranking model that optimizes an nDCG ranking evaluation metric for the training data to rank a list of search results of a search query. The server may receive a search query, and a search engine operably coupled to the server and the computer-readable storage, may retrieve search results for the query and apply the optimized nDCG ranking model to rank a list of search results of the search query. The server may send the list of search results ranked by the optimized nDCG ranking model for the search query to an operably coupled web browser executing on a client device for display.

To generate an optimized nDCG ranking model, a combination of weak ranking classifiers may be iteratively learned that optimize an approximation of an average nDCG ranking evaluation metric for the training data. At each iteration in an embodiment, a weight may be computed for each document in the training data that indicates the difference of a rank position at the iteration and the true rank position in training data; a class label may be assigned for each document in the training data that indicates the sign of a computed weight; and a weak ranking classifier may be trained for each document in the training data with the computed weight and assigned class label. A ranking value may be predicted using the weak ranking classifier for each document in the training data, and a combination weight may be computed for the weak ranking classifier for adding the weak ranking classifier to the optimized nDCG ranking model. The optimized nDCG ranking model may then be updated at each iteration by adding the weak ranking classifier with a combination weight to the optimized nDCG ranking model.

Advantageously, the present invention may directly optimized an approximation of an average nDCG ranking evaluation metric efficiently through an iterative boosting method for learning to more accurately rank a list of documents for a query. The present invention may accordingly be applied to rank a list of search results for any search system, including a recommender system, an online search engine system, a document retrieval system, an advertisement serving system and so forth. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for learning a ranking model that optimizes a ranking evaluation metric for ranking search results of a search query, in accordance with an aspect of the present invention;

FIG. 3 is a flowchart generally representing the steps undertaken in one embodiment for learning a ranking model that optimizes a ranking evaluation metric for ranking search results of a search query, in accordance with an aspect of the present invention;

FIG. 4 is a flowchart generally representing the steps undertaken in one embodiment for iteratively learning a combination of weak ranking classifiers that optimize an approximation of an average nDCGnDCGnDCG measure to generate an nDCGnDCGnDCG ranking model, in accordance with an aspect of the present invention; and

FIG. 5 is a flowchart generally representing the steps undertaken in one embodiment on a server to use the optimized nDCG ranking model to rank a list of search results retrieved during query processing to send to a web browser executing on the client for display, in accordance with an aspect of the present invention.

### DETAILED DESCRIPTION

### Exemplary Operating Environment

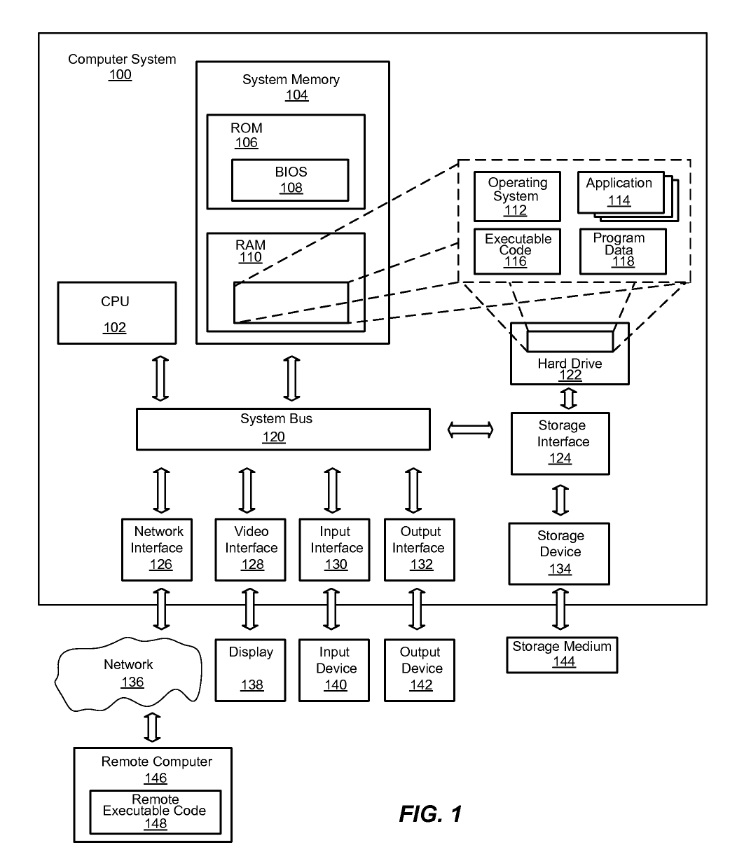

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

Learning a Ranking Model that Optimizes a Ranking Evaluation Metric for Ranking for Search Results of a Search Query

The present invention is generally directed towards a system and method for learning a ranking model that optimizes a ranking evaluation metric for ranking search results of a search query. To generate an optimized nDCG ranking model, a combination of weak ranking classifiers may be iteratively learned that optimize an approximation of an average nDCG ranking evaluation metric for the training data. At each iteration in an embodiment, a weight may be computed for each document in the training data that indicates the difference of a rank position at the iteration and the true rank position in training data. A class label may be assigned for each document in the training data that indicates the sign of a computed weight, and a weak ranking classifier may be trained for each document in the training data with the computed weight and assigned class label. A ranking value may be predicted using the weak ranking classifier for each document in the training data, and a combination weight may be computed for the weak ranking classifier for adding the weak ranking classifier to the optimized nDCG ranking model. The optimized nDCG ranking model may then be updated at each iteration by adding the weak ranking classifier with a combination weight to the optimized nDCG ranking model.

As will be seen, a search query may be received and the optimized nDCG ranking model may be used to rank a list of search results retrieved during query processing to send to a web browser executing on the client for display. As will be understood, the various block diagrams, flow charts and scenarios described herein are only examples, and there are many other scenarios to which the present invention will apply.

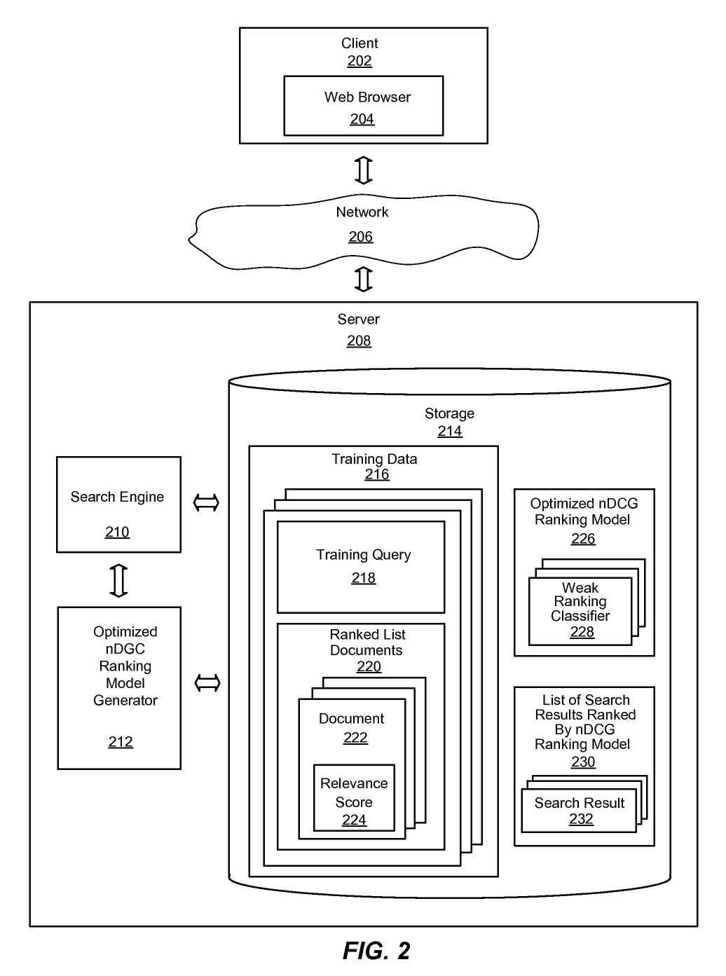

Turning to FIG. 2 of the drawings, there is shown a block diagram generally representing an exemplary architecture of system components for learning a ranking model that optimizes a ranking evaluation metric for ranking search results of a search query. Those skilled in the art will appreciate that the functionality implemented within the blocks illustrated in the diagram may be implemented as separate components or the functionality of several or all of the blocks may be implemented within a single component. For example, the functionality for the optimized nDCG ranking model generator 212 may be included in the same component as the search engine 210. Or the functionality of the optimized nDCG ranking model generator 212 may be implemented as a separate component from the search engine 210 as shown. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a search request which may be input by a user entering a query, functionality for sending the query request to a search engine to obtain a list of search results, and functionality for receiving a list of search results from a server for display by the web browser, for instance, in a search results page on the client device. In general, the web browser 204 may be any type of interpreted or executable software code such as a kernel component, an application program, a script, a linked library, an object with methods, and so forth. The web browser 204 may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The server 208 may be any type of computer system or computing device such as computer system 100 of FIG. 1. In general, the server 208 may provide services for receiving a search query, processing the query to retrieve search results, ranking the search results, and sending a ranked list of search results to the web browser 204 executing on the client 202 for display. In particular, the server 208 may include a search engine 210 that may include functionality for query processing including retrieving search results and ranking the search results. The server 208 may also include an optimized nDCG ranking model generator 212 that may construct a ranking model that optimizes the nDCG ranking evaluation metric for ranking search results of a search query. Each of these components may also be any type of executable software code such as a kernel component, an application program, a linked library, an object with methods, or other type of executable software code. These components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The server 208 may be operably coupled to storage 214 that may store training data 216 that may be used to iteratively learn a ranking model that optimizes an nDCG value. The training data 216 may include sets of a training query 218 and a ranked list of documents 220. There may be a relevance score 224 included for each document 222 in the ranked list of documents 220. The storage 214 may also store an optimized nDCG ranking model 226 of a combination of weak ranking classifiers 228 that optimize an nDCG ranking evaluation metric for ranking search results of a search query. The optimized nDCG ranking model generator 212 may construct the optimized nDCG ranking model 226 by iteratively learning a combination of weak ranking classifiers 228 that optimize the nDCG ranking evaluation metric for ranking search results of a search query. And the search engine 210 may use the optimized nDCG ranking model 226 to rank a list of search results retrieved during query processing to send to the web browser 204 executing on the client 202 for display. In an embodiment, the list of search results ranked by the nDCG ranking model 230 may be stored in storage 214. Each search result 232 may represent descriptive text including a document address such as a Uniform Resource Locator (URL) of a web page.

Online search engine operators may use the optimized nDCG ranking model to rank a list of search results retrieved during query processing to send to a web browser executing on the client for display. In various embodiments, a ranking model may be learned that optimizes a ranking evaluation metric for ranking search results of a search query. Importantly, the present invention may generally be used for learning a ranking model that optimizes a ranking evaluation metric for ranking documents retrieved for a search query, including electronic documents stored on a single storage device or stored across several storage devices. Recommender systems, for instance, may use the present invention to rank objects described by text to be recommended in response to a search or selection of an object. For any search system, including a recommender system, an online search engine system, a document retrieval system, and so forth, the present invention may be applied to rank a list of search results that optimizes a ranking evaluation metric.

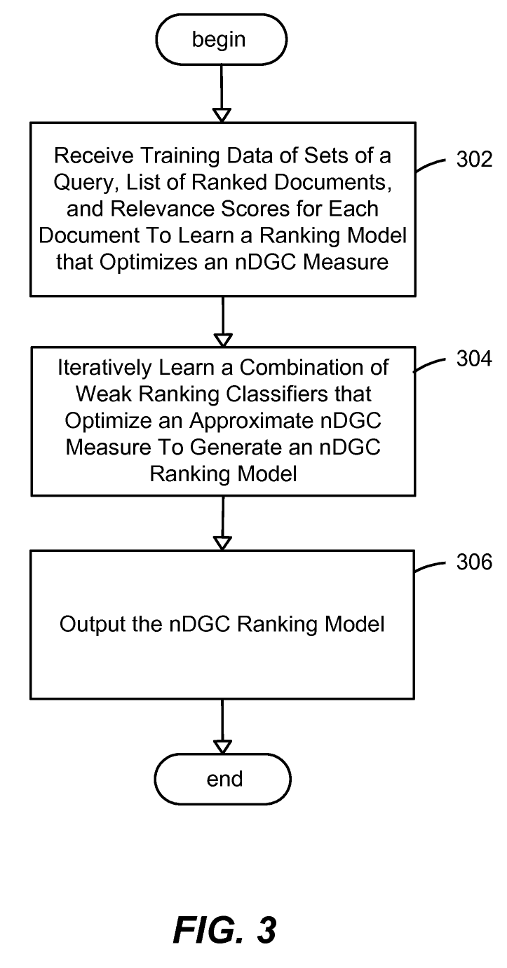

FIG. 3 presents a flowchart generally representing the steps undertaken in one embodiment for learning a ranking model that optimizes a ranking evaluation metric for ranking search results of a search query. At step 302, training data sets of a query, list of ranked documents, and relevance scores for each document may be received to learn a ranking model that optimizes an nDCGnDCGnDCG measure. Consider a collection of n queries for training, denoted by Q={q¹, . . . ,qⁿ}. For each query q^{k}, there may be collection of mₖ documents denoted by D^{k}={dᵢ^{k},i=1, . . . ,mₖ}, whose relevance to q^{k} may be given by a vector r^{k}=(r₁^{k}, . . . ,rₘ_{ₖ}^{k})εZ^{m}^{ₖ}. The ranking function F(d,q) may take a document-query pair (d,q) and output a real number score. The rank of document dᵢ^{k} within the collection D^{k} for query q^{k} may be denoted by jᵢ^{k}. The nDCG value for ranking function F(d,q) may then be computed by the following equation:

$$L ( Q , F ) = \frac{1}{n} {\sum }_{k = 1}^{n} \frac{1}{{Z}_{k}} {\sum }_{i = 1}^{{m}_{k}} \frac{{2}^{{r}_{i}^{k}} - 1}{log ( 1 + {j}_{i}^{k} )} .$$

One of the main challenges in direct optimization of the nDCG metric defined in

$$L ( Q , F ) = \frac{1}{n} {\sum }_{k = 1}^{n} \frac{1}{{Z}_{k}} {\sum }_{i = 1}^{{m}_{k}} \frac{{2}^{{r}_{i}^{k}} - 1}{log ( 1 + {j}_{i}^{k} )}$$

is that it depends on document ranks, jᵢ^{k}, and not directly on the numerical values output by the ranking function F(d,q). This makes it computationally challenging. To address this problem, a probabilistic framework may be introduced and the expectation of the nDCG measure averaged over the possible rankings that are induced by the ranking function F(d,q) may be optimized. The expectation of the nDCG measure may be computed by the following equation:

$$\overline{L} ( Q , F ) = \frac{1}{n} {\sum }_{k = 1}^{n} \frac{1}{{Z}_{k}} {\sum }_{i = 1}^{{m}_{k}} 〈 \frac{{2}^{{r}_{i}^{k}} - 1}{log ( 1 + {j}_{i}^{k} )} 〉 = \frac{1}{n} {\sum }_{k = 1}^{n} \frac{1}{{Z}_{k}} {\sum }_{i = 1}^{{m}_{k}} {\sum }_{{π}^{k} ∈ {S}_{{m}_{k}}} Pr ( {π}^{k} \vert F , {q}^{k} ) \frac{{2}^{{r}_{i}^{k}} - 1}{log ( 1 + {π}^{k} ( i ) )}$$

where Sₘ_{ₖ} denotes the group of permutations of mₖ objects, π^{k} is an instance of a permutation or ranking, and π^{k}(i) denotes the ranking of the ith object by π^{k}.

To simplify maximizing L̅(Q,F), a relaxation may be used to approximate the average of nDCG over the space of permutation induced by the ranking function F(d,q). For any distribution Pr(π|F,q), the following inequality holds L̅(Q,F)≧ H̅(Q,F), where

$$\overline{H} ( Q , F ) = \frac{1}{n} {\sum }_{k = 1}^{n} \frac{1}{{Z}_{k}} {\sum }_{i = 1}^{{m}_{k}} \frac{{2}^{{r}_{i}^{k}} - 1}{log ( 1 {〈 {π}^{k} ( i ) 〉}_{F} )} .$$

Given H̅(Q,F) provides a lower bound for L̅(Q,F), H̅(Q,F) could alternatively be maximized in order to maximize L̅(Q,F). Approximating [symbol] π^{k}(i) [symbol] as

$$〈 {π}^{k} ( i ) 〉 \approx 1 + {\sum }_{j = 1}^{{m}_{k}} \frac{1}{1 + exp ( {F}_{i}^{k} - {F}_{j}^{k} )}$$

where Fᵢ^{k}=2F(dᵢ^{k},q^{k}), H̅(Q,F) may be approximated by

$$\overline{H} ( Q , F ) \approx \frac{1}{n} {\sum }_{k = 1}^{n} \frac{1}{{Z}_{k}} {\sum }_{i = 1}^{{m}_{k}} \frac{{2}^{{r}_{i}^{k}} - 1}{log ( 2 + {A}_{i}^{k} )} ,$$

where

$${A}_{i}^{k} = {\sum }_{j = 1}^{{m}_{k}} \frac{I ( j \neq i )}{1 + exp ( {F}_{i}^{k} - {F}_{j}^{k} )} .$$

To maximize the approximation of H̅(Q,F), a bound optimization strategy may be employed to iteratively update the solution for the ranking function F(d,q) with the addition of a weak ranking classifier such as a binary classification function f(d,q). To improve the nDCG value, the ranking function may be updated as follows:

F(dᵢ^{k})←F(dᵢ^{k})+αf(dᵢ^{k}), where α>0 may be a combination weight and f(dᵢ^{k})=f(dᵢ^{k},q^{k})ε{0,1}.

Accordingly, at step 304, a combination of weak ranking classifiers that optimize an approximate nDCG measure may be iteratively learned to generate an nDCG ranking model. In an embodiment, each weak ranking classifier may be a binary classifier trained by example documents that are labeled as positive or negative. And the nDCG ranking model may be output at step 306. In an embodiment, the nDCG ranking model may be stored in computer-readable storage and may be represented as a forest of weighted decision trees with leaf nodes of ranking scores.

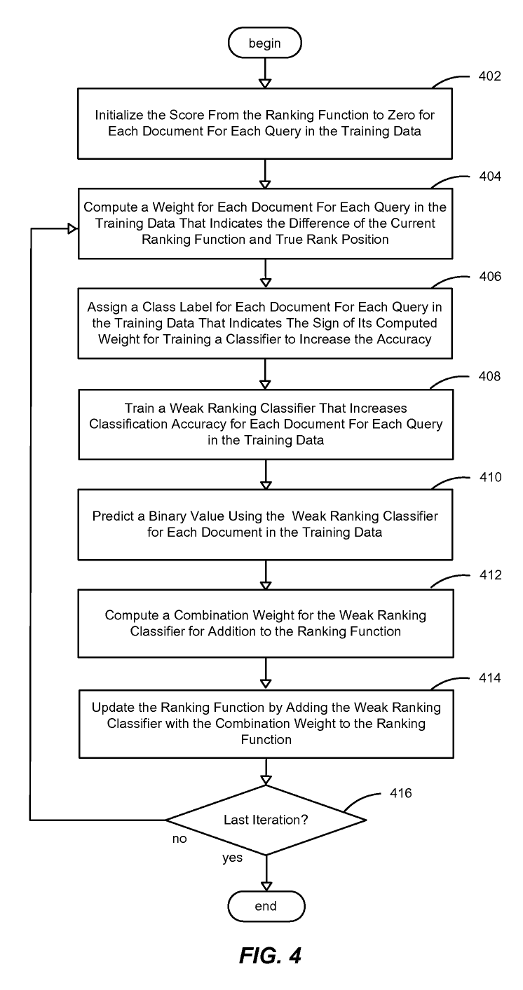

FIG. 4 presents a flowchart generally representing the steps undertaken in one embodiment for iteratively learning a combination of weak ranking classifiers that optimize an approximation of an average nDCG measure to generate an nDCG ranking model. To employ the bound optimization strategy to iteratively update the solution for the ranking function F(d,q) with the addition of a weak ranking classifier, a lower bound may be constructed for H̅(Q,F) as

$$\frac{1}{log ( 2 + {A}_{i}^{k} ( \tilde{F} ) )} \geq \frac{1}{log ( 2 + {A}_{i}^{k} ( F ) )} - {\sum }_{j = 1}^{m} {θ}_{i , j}^{k} [ exp ( α ( {f}_{j}^{k} - {f}_{i}^{k} ) ) - 1 ] ,$$

where

$${θ}_{i , j}^{k} = \frac{{γ}_{i , j}^{k}}{{[ log ( 2 + {A}_{i}^{k} ( F ) ) ]}^{2} ( 2 + {A}_{i}^{k} ( F ) )} I ( j \neq i )$$

$$and {γ}_{i , j}^{k} = \frac{exp ( {F}_{i}^{k} - {F}_{j}^{k} )}{{( 1 + exp ( {F}_{i}^{k} - {F}_{j}^{k} ) )}^{2}} .$$

At step 402, the score from the ranking function may be initialized to zero for each document for each query in the training data. At step 404, a weight, wᵢ^{k}, for each document for each query in the training data may be computed that indicates the difference of the current ranking function and true rank position in the training data. In an embodiment, θ_{i,j}^{k} may be computed for every pair of documents (i,j) in the list of documents for every query q^{k}, and the weight wᵢ^{k} for each document for each query in the training data may be computed by the following function:

$${w}_{i}^{k} = \frac{{2}^{{r}_{i}^{k}} - 1}{{Z}_{k}} {\sum }_{j = 1}^{{m}_{k}} {θ}_{i , j}^{k} - {\sum }_{j = 1}^{{m}_{k}} \frac{{2}^{{r}_{i}^{k}} - 1}{{Z}_{k}} {θ}_{i , j}^{k} .$$

At step 406, a class label may be assigned for each document for each query in the training data that indicates the sign of its computed weight for training a classifier to increase the accuracy. Note that weight wᵢ^{k} can be positive or negative. A positive weight wᵢ^{k} indicates that the ranking position of dᵢ^{k} induced by the current ranking function F is less than its true rank position in the training data, while a negative weight wᵢ^{k} indicates that ranking position of dᵢ^{k} induced by the current ranking function F is greater than its true rank position in the training data. Therefore, the sign of weight wᵢ^{k} provides clear guidance for how to construct the next weak ranking classifier. The examples with a positive weight wᵢ^{k} should be labeled as +1 and those with negative weight wᵢ^{k} should be labeled as −1. The magnitude of weight wᵢ^{k} may indicate how much the corresponding example is misplaced in the ranking from its true rank position in the training data. Thus the magnitude of weight wᵢ^{k} may indicate the importance of correcting the ranking position of example dᵢ^{k} in terms of improving the value of nDCG metric.

At step 408, a weak ranking classifier may be trained that increases classification accuracy for each document for each query in the training data. In an embodiment, a classifier f(x):R^{d}→{0,1} may be trained that maximizes the quantity

$$η = {\sum }_{k = 1}^{n} {\sum }_{i = 1}^{{m}_{k}} \vert {w}_{i}^{k} \vert f ( {d}_{i}^{k} ) {y}_{i}^{k} .$$

A sampling strategy may be used in an embodiment in order to maximize η because most binary classifiers do not support the weighted training set. Examples of documents may first be sampled according to |wᵢ^{k}| and then a binary classifier may be constructed with the sampled examples.

At step 410, a binary value may be predicted using the weak ranking classifier f(dᵢ^{k}) for every document of every query. A combination weight α may then be computed at step 412 for the weak ranking classifier which shows the importance of the current weak ranker f(d) in ranking. In an embodiment, the combination weight α may be computed by the following

$$α = \frac{1}{2} log ( \frac{{\sum }_{k = 1}^{n} {\sum }_{i , j = 1}^{{m}_{k}} \frac{{2}^{{r}_{i}^{k}} - 1}{{Z}_{k}} {θ}_{i , j}^{k} I ( {f}_{j}^{k} < {f}_{i}^{k} )}{{\sum }_{k = 1}^{n} {\sum }_{i , j = 1}^{{m}_{k}} \frac{{2}^{{r}_{i}^{k}} - 1}{{Z}_{k}} {θ}_{i , j}^{k} I ( {f}_{j}^{k} > {f}_{i}^{k} )} ) .$$

equation:

At step 414, the ranking function may be updated by adding the weak ranking classifier with the combination weight to the ranking function so that F(dᵢ^{k})←F(dᵢ^{k})+αf(dᵢ^{k}). It may be determined at step 416 whether this is the last iteration of updating the ranking function or whether another iteration should occur. In an embodiment, the number of iterations may be fixed number such as 100 iterations. In other embodiments, the last iteration may occur when there is convergence of the nDCG measure such as a difference of less than 1/1000 of the approximation of the nDCG measure between the last two iterations. If it may not be the last iteration, then processing may continue at step 404 where a weight, wᵢ^{k}, for each document for each query in the training data may be computed that indicates the difference of the current ranking function and true rank position in the training data. Otherwise processing may be finished for iteratively learning a combination of weak ranking classifiers that optimize an approximate average nDCG measure to generate an nDCG ranking model.

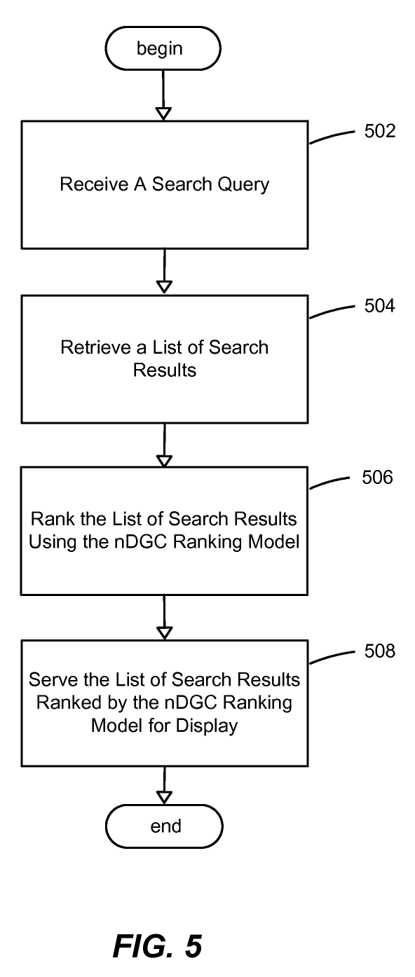

FIG. 5 presents a flowchart generally representing the steps undertaken in one embodiment on a server to use the optimized nDCG ranking model to rank a list of search results retrieved during query processing to send to a web browser executing on the client for display. At step 502, a search query may be received, for instance by a search engine executing on a server. A list of search results may then be retrieved at step 504 by the search engine. At step 506, the list of search results may be ranked using the nDCG ranking model, and the list of search results ranked by the nDCG ranking model may be served for display at step 508. In an embodiment, the list of search results ranked by the nDCG ranking model may be served to a web browser executing on a client device for display.

Thus the present invention may directly optimize an approximation of an average nDCG ranking evaluation metric efficiently through an iterative boosting technique for learning to more accurately rank a list of documents for a query. A lower bound of the nDCG expectation over the possible rankings of the training documents that are induced by the ranking function can be directly optimized. To simplify maximizing the nDCG expectation, a relaxation may be used to approximate the average of nDCG over the space of permutation induced by the ranking function, and a bound optimization strategy may be employed to iteratively update the solution for the ranking function with the addition of a weak ranking classifier such as a binary classification function.

As can be seen from the foregoing detailed description, the present invention provides an improved system and method for learning a ranking model that optimizes a ranking evaluation metric for ranking search results of a search query. An optimized nDCG ranking model that optimizes an approximation of an average nDCG ranking evaluation metric may be generated from training data through an iterative boosting method for learning to more accurately rank a list of search results for a query. A combination of weak ranking classifiers may be iteratively learned that optimize an approximation of an average nDCG ranking evaluation metric for the training data by training a weak ranking classifier at each iteration using a training set which includes a weighted and binary labeled version of each document, and then updating the optimized nDCG ranking model by adding the weak ranking classifier with a combination weight to the optimized nDCG ranking model. For any search system, including a recommender system, an online search engine system, a document retrieval system, and so forth, the present invention may be applied to rank a list of search results that optimizes a ranking evaluation metric. As a result, the system and method provide significant advantages and benefits needed in contemporary computing, in online search applications, and in information retrieval applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for ranking search results of a search query, comprising:
an optimized nDCG ranking model generator that optimizes an nDCG ranking evaluation metric to generate from a plurality of sets of training data, each set including at least one training search query and at least one ranked list of documents, a nDCG ranking model that ranks a list of search results of a search query; and
a storage, operably coupled to the optimized nDCG ranking model generator, that stores the optimized nDCG ranking model and the plurality of sets of training data.

2. The system of claim 1 further comprising a search engine, operably coupled to the storage, that uses the optimized nDCG ranking model to rank and output the list of search results of the search query.

3. The system of claim 1 further comprising a server, operably coupled to the search engine, that serves the list of search results ranked by the optimized nDCG ranking model for the search query to a web browser executing on a client device for display.

4. The system of claim 3 further comprising the web browser executing on the client device, operably coupled to the server, that displays the list of search results ranked by the optimized nDCG ranking model for the search query.

5. A computer-readable storage medium having computer-executable components comprising the system of claim 1.

6. A computer-implemented method for ranking search results of a search query, comprising:
receiving a plurality of search results for a search query;
applying an optimized nDCG ranking model that optimizes an approximation of an average nDCG ranking evaluation metric for a plurality of training data to rank the plurality of search results for the search query; and
serving the plurality of search results ranked by the optimized nDCG ranking model for the search query to display on a device.

7. The method of claim 6 further comprising receiving the search query.

8. The method of claim 6 further comprising displaying the plurality of search results ranked by the optimized nDCG ranking model for the search query on a web browser executing on a client device.

9. The method of claim 6 further comprising iteratively learning a combination of weak ranking classifiers that optimize the approximation of the average nDCG ranking evaluation metric for the plurality of training data to generate the optimized nDCG ranking model to rank the plurality of search results for the search query.

10. The method of claim 9 further comprising receiving the plurality of training data, including at least one training search query and at least one ranked list of documents.

11. The method of claim 9 further comprising outputting the optimized nDCG ranking model to rank the plurality of search results for the search query.

12. The method of claim 9 wherein iteratively learning the combination of weak ranking classifiers that optimize the approximation of the average nDCG ranking evaluation metric for the plurality of training data to generate the optimized nDCG ranking model to rank the plurality of search results for the search query comprises computing a weight for each of a plurality of documents in the plurality of training data that indicates the difference of a rank position in an iteration and a rank position in the plurality of training data.

13. The method of claim 9 wherein iteratively learning the combination of weak ranking classifiers that optimize the approximation of the average nDCG ranking evaluation metric for the plurality of training data to generate the optimized nDCG ranking model to rank the plurality of search results for the search query comprises assigning a class label for each of a plurality of documents in the plurality of training data that indicates a sign of a computed weight.

14. The method of claim 9 wherein iteratively learning the combination of weak ranking classifiers that optimize the approximation of the average nDCG ranking evaluation metric for the plurality of training data to generate the optimized nDCG ranking model to rank the plurality of search results for the search query comprises training a weak ranking classifier each iteration for the plurality of training data.

15. The method of claim 9 wherein iteratively learning the combination of weak ranking classifiers that optimize the approximation of the average nDCG ranking evaluation metric for the plurality of training data to generate the optimized nDCG ranking model to rank the plurality of search results for the search query comprises computing a combination weight each iteration for a weak ranking classifier for addition to a ranking function.

16. The method of claim 9 wherein iteratively learning the combination of weak ranking classifiers that optimize the approximation of the average nDCG ranking evaluation metric for the plurality of training data to generate the optimized nDCG ranking model to rank the plurality of search results for the search query comprises updating the optimized nDCG ranking model each iteration by adding a weak ranking classifier with a combination weight to a ranking function.

17. A computer-readable storage medium having computer-executable instructions for performing the method of claim 6.

18. A computer system for ranking search results of a search query, comprising:
means for receiving a plurality of training data, including at least one training search query and at least one ranked list of documents;
means for iteratively learning a combination of weak ranking classifiers that optimize an approximation of an average nDCG ranking evaluation metric for the plurality of training data to generate an optimized nDCG ranking model to rank a plurality of search results for a search query; and
means for outputting the optimized nDCG ranking model to rank the plurality of search results for the search query.

19. The computer system of claim 18 further comprising:
means for receiving the search query;
means for applying the optimized nDCG ranking model to rank the plurality of search results for the search query; and
means for serving the plurality of search results ranked by the optimized nDCG ranking model for the search query to display on a device.

20. The computer system of claim 19 further comprising means for displaying the plurality of search results ranked by the optimized nDCG ranking model for the search query.
